(19) United States
(12) Patent Application Publication
(10) Pub. No.: US 2019/0206215 A1
(43) Pub. Date: Jul. 4, 2019

(54) Proximity Induced Messaging Device

(71) Applicants: Sebourn Ferguson, Bardwell, KY (US); Victoria Ferguson, Bardwell, KY (US)

(72) Inventors: Sebourn Ferguson, Bardwell, KY (US); Victoria Ferguson, Bardwell, KY (US)

(21) Appl. No.: 15/861,281

(22) Filed: Jan. 3, 2018

(51) Int. Cl. G08B 15/00; A63H 3/28; G01S 17/02; A63H 13/00; G09F 19/08

(52) U.S. Cl. CPC G08B 15/002; A63H 3/28; G09F 19/08; A63H 13/005; G01S 17/026

(57) ABSTRACT

A proximity induced messaging device for greeting a person arriving at an entrance of a structure includes a housing that defines an interior space. The housing is configured to couple to a structure proximate to the entrance of the structure. A power module is coupled to the housing and is positioned in the interior space. A sensor and a communication module are coupled to the housing and are operationally coupled to the power module. The communication module is operationally coupled to the sensor. The sensor is configured to detect a person entering an area proximate to the housing and to signal the communication module. The communication module is positioned to broadcast a greeting.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to messaging devices and more particularly pertains to a new messaging device for greeting a person arriving at an entrance of a structure.

### BRIEF SUMMARY OF THE INVENTION

An embodiment of the disclosure meets the needs presented above by generally comprising a housing that defines an interior space. The housing is configured to couple to a structure proximate to an entrance of the structure. A power module is coupled to the housing and is positioned in the interior space. A sensor and a communication module are coupled to the housing and are operationally coupled to the power module. The communication module is operationally coupled to the sensor. The sensor is configured to detect a person entering an area proximate to the housing and to signal the communication module. The communication module is positioned to broadcast a greeting.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a proximity induced messaging device according to an embodiment of the disclosure.

FIG. 2 is a side view of an embodiment of the disclosure.

FIG. 3 is a rear view of an embodiment of the disclosure.

FIG. 4 is a block diagram of an embodiment of the disclosure.

### DETAILED DESCRIPTION OF THE INVENTION

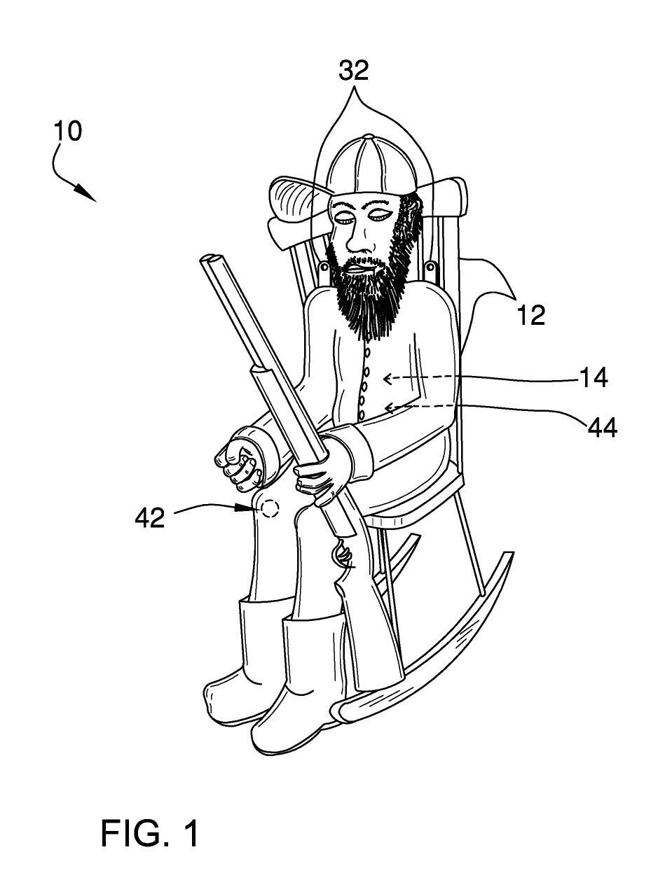

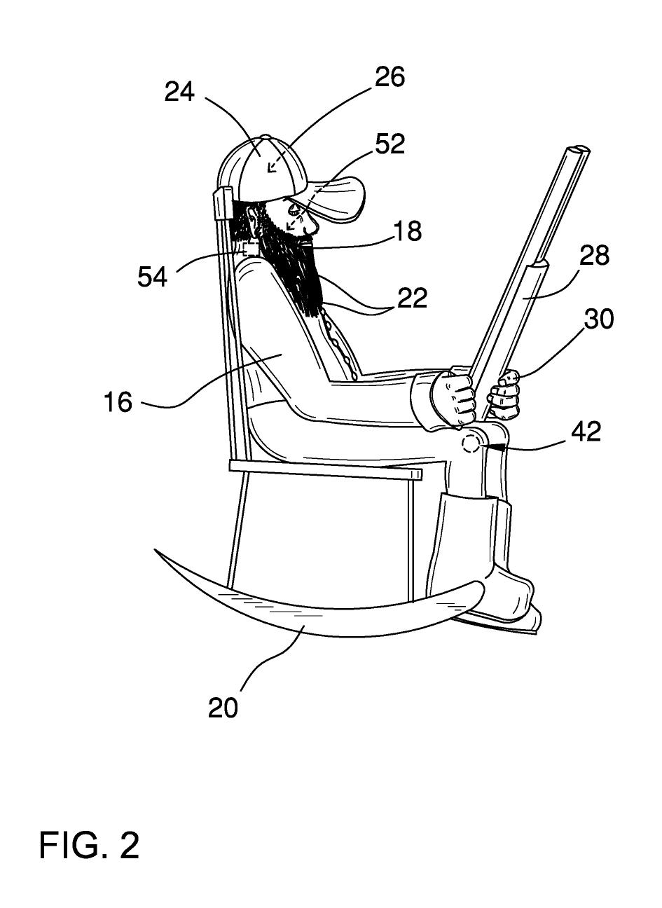

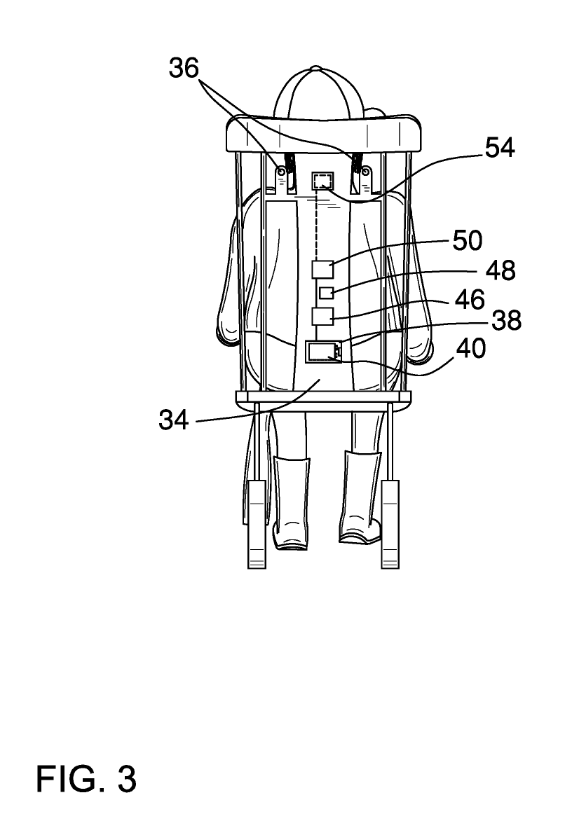

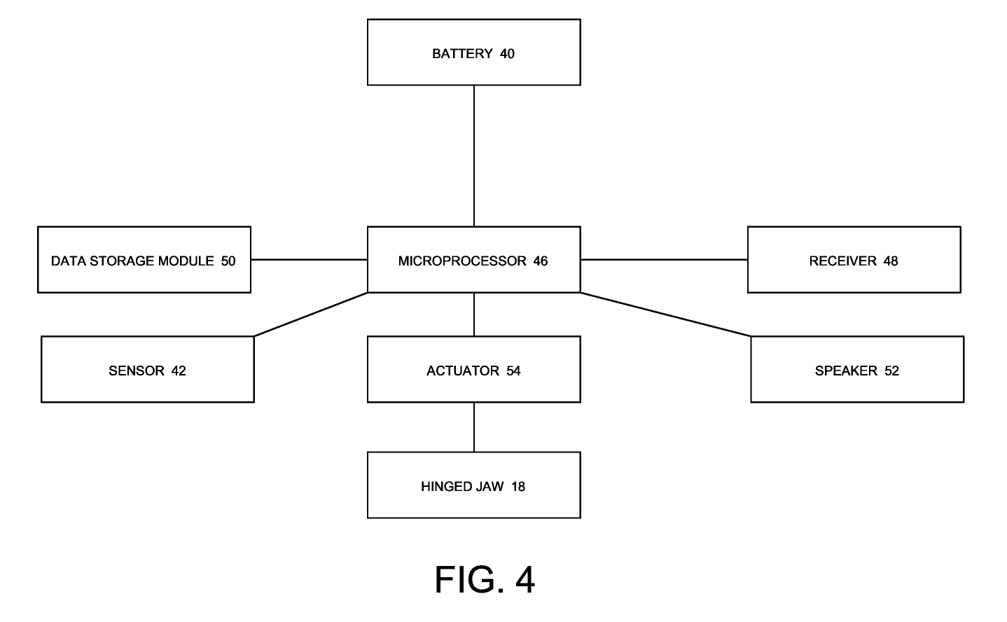

With reference now to the drawings, and in particular to FIGS. 1 through 4 thereof, a new messaging device embodying the principles and concepts of an embodiment of the disclosure and generally designated by the reference numeral 10 will be described.

As best illustrated in FIGS. 1 through 4, the proximity induced messaging device 10 generally comprises a housing 12 that defines an interior space 14. The housing 12 is configured to couple to a structure proximate to an entryway of the structure. The housing 12 comprises a human FIG. 16, or the like. The human FIG. 16 comprises a hinged jaw 18. The human FIG. 16 is elderly and male.

A rocking chair 20 is coupled to the human FIG. 16 so that the human FIG. 16 appears to be seated in the rocking chair 20. A plurality of bristles 22 is coupled to the human FIG. 16 so that the human FIG. 16 is bearded. A cap 24 is coupled to a head 26 of the human FIG. 16. A prop 28, which is shotgun shaped, is coupled to a hand 30 of the human FIG. 16.

A coupler 32 is coupled to a back 34 of the housing 12. The coupler 32 is configured to couple the housing 12 to the structure. The coupler 32 comprises a pair of holes 36. Each hole 36 is positioned through the back 34 of the housing 12 so that each hole 36 is positioned to insert a respective article of mounting hardware, such as a screw or a nail, to couple the housing 12 to the structure.

A power module 38 is coupled to the housing 12 and is positioned in the interior space 14. The power module 38 comprises a battery 40. A sensor 42 is coupled to the housing 12. The sensor 42 is operationally coupled to the power module 38. The sensor 42 is configured to detect a person who enters an area proximate to the housing 12. The sensor 42 is passive infrared-type, or the like.

A communication module 44 is coupled to the housing 12. The communication module 44 is operationally coupled to the sensor 42 and the power module 38. The sensor 42 is configured to detect the person who enters the area proximate to the housing 12 and to signal the communication module 44. The communication module 44 is positioned to broadcast a greeting to the person who enters the area proximate to the housing 12.

The communication module 44 comprises a microprocessor 46, a receiver 48, a data storage module 50 and a speaker 52. The microprocessor 46, the receiver 48, and the data storage module 50 are coupled to the housing 12 and are positioned in the interior space 14. The receiver 48, the data storage module 50, and the speaker 52 are operationally coupled to the microprocessor 46.

The receiver 48 is configured to communicate wirelessly, such as by being Bluetooth™ enabled, so that the receiver 48 is configured to receive a command from an electronic device of a user. The data storage module 50 is configured to store a plurality of audio files. The receiver 48 is positioned to selectively transfer the plurality of audio files from the electronic device of the user to the data storage module 50. The microprocessor 46 is positioned to effect the command to require the data storage module 50 to broadcast a respective audio file via the speaker 52 to the person proximate to the housing 12. Depending on the user's selection of the respective audio file, the greeting comprises music, a welcoming message, a warning not to disturb, or the like.

An actuator 54 is coupled to the housing 12. The actuator 54 is operationally coupled to the microprocessor 46 and the hinged jaw 18. The microprocessor 46 is positioned to motivate the actuator 54 to selectively pivot the hinged jaw 18 concurrent with the speaker 52 broadcasting the respective audio file. In this manner, the human FIG. 16 appears to be giving voice to the respective audio file.

In use, each hole 36 is positioned to insert the respective article of the mounting hardware to couple the housing 12 to the structure. The receiver 48 is positioned to selectively transfer the plurality of audio files and the command from the electronic device of the user to the data storage module 50. The sensor 42 is configured to detect the person who enters the area proximate to the housing 12 and to signal the microprocessor 46. The microprocessor 46 is positioned to effect the command to require the data storage module 50 to broadcast the respective audio file via the speaker 52 to the person proximate to the housing 12. The microprocessor 46 is positioned to motivate the actuator 54 to selectively pivot the hinged jaw 18 concurrent with the speaker 52 broadcasting the respective audio file.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A proximity induced messaging device comprising:
a housing defining an interior space, said housing being configured for coupling to a structure proximate to an entryway of the structure, said housing comprising a human figure;
a power module coupled to said housing and positioned in said interior space;
a sensor coupled to said housing, said sensor being operationally coupled to said power module, said sensor being configured for detecting a person entering an area proximate to said housing;
a communication module coupled to said housing, said communication module being operationally coupled to said sensor and said power module;
a coupler coupled to a back of said housing, said coupler being configured for coupling said housing to the structure, said coupler comprising a pair of holes, each said hole being positioned through said back of said housing, wherein said holes are positioned in said housing such that each said hole is positioned for inserting a respective article of mounting hardware for coupling said housing to the structure; and
wherein said sensor is positioned on said housing such that said sensor is configured for detecting the person entering the area proximate to said housing and for signaling said communication module such that said communication module is positioned for broadcasting a greeting.

2. (canceled)

3. The device of claim 1, further including said human figure being elderly.

4. The device of claim 1, further including said human figure being male.

5. (canceled)

6. (canceled)

7. The device of claim 1, further including a rocking chair coupled to said human figure such that said human figure is seated in said rocking chair.

8. The device of claim 4, further including a plurality of bristles coupled to said human figure such that said human figure is bearded.

9. The device of claim 1, further including a cap coupled to a head of said human figure.

10. The device of claim 1, further including a prop coupled to a hand of said human figure, said prop being shotgun shaped.

11. The device of claim 1, further including said power module comprising a battery.

12. The device of claim 1, further including said sensor being a passive infrared sensor.

13. The device of claim 1, further including said communication module comprising:
a microprocessor coupled to said housing and positioned in said interior space;
a receiver coupled to said housing and positioned in said interior space, said receiver being operationally coupled to said microprocessor, said receiver being configured for wireless communication such that said receiver is configured for receiving a command from an electronic device of a user;
a data storage module coupled to said housing and positioned in said interior space, said data storage module being operationally coupled to said microprocessor, said data storage module being configured for storing a plurality of audio files;
a speaker coupled to said housing, said speaker being operationally coupled to said microprocessor; and
wherein said data storage module is positioned in said housing such that said receiver is positioned for selectively transferring the plurality of audio files from the electronic device of the user to said data storage module, wherein said speaker is positioned on said housing such that said microprocessor is positioned for effecting the command requiring said data storage module to broadcast a respective audio file via said speaker to the person proximate to said housing.

14. The device of claim 13, further including said receiver being Bluetooth™ enabled.

15. The device of claim 13, further including comprising:
said housing comprising a human figure, said human figure comprising a hinged jaw;
an actuator coupled to said housing, said actuator being operationally coupled to said microprocessor and said hinged jaw; and
wherein said actuator is positioned on said hinged jaw such that said microprocessor is positioned for motivating said actuator for selectively pivoting said hinged jaw concurrent with said speaker broadcasting the respective audio file.

16. A proximity induced messaging device comprising:
a housing defining an interior space, said housing being configured for coupling to a structure proximate to an entryway of the structure, said housing comprising a human figure, said human figure comprising a hinged jaw, said human figure being elderly, said human figure being male;
a coupler coupled to a back of said housing, said coupler being configured for coupling said housing to the structure, said coupler comprising a pair of holes, each said hole being positioned through said back of said housing, wherein said holes are positioned in said housing such that each said hole is positioned for inserting a respective article of mounting hardware for coupling said housing to the structure;
a rocking chair coupled to said human figure such that said human figure is seated in said rocking chair;
a plurality of bristles coupled to said human figure such that said human figure is bearded;
a cap coupled to a head of said human figure;
a prop coupled to a hand of said human figure, said prop being shotgun shaped;
a power module coupled to said housing and positioned in said interior space, said power module comprising a battery;
a sensor coupled to said housing, said sensor being operationally coupled to said power module, said sensor being configured for detecting a person entering an area proximate to said housing, said sensor being a passive infrared sensor;
a communication module coupled to said housing, said communication module being operationally coupled to said sensor and said power module, wherein said sensor is positioned on said housing such that said sensor is configured for detecting the person entering the area proximate to said housing and for signaling said communication module such that said communication module is positioned for broadcasting a greeting, said communication module comprising:
a microprocessor coupled to said housing and positioned in said interior space,
a receiver coupled to said housing and positioned in said interior space, said receiver being operationally coupled to said microprocessor, said receiver being configured for wireless communication such that said receiver is configured for receiving a command from an electronic device of a user, said receiver being Bluetooth™ enabled,
a data storage module coupled to said housing and positioned in said interior space, said data storage module being operationally coupled to said microprocessor, said data storage module being configured for storing a plurality of audio files, wherein said data storage module is positioned in said housing such that said receiver is positioned for selectively transferring the plurality of audio files from the electronic device of the user to said data storage module, and
a speaker coupled to said housing, said speaker being operationally coupled to said microprocessor, wherein said speaker is positioned on said housing such that said microprocessor is positioned for effecting the command requiring said data storage module to broadcast a respective audio file via said speaker to the person proximate to said housing;
an actuator coupled to said housing, said actuator being operationally coupled to said microprocessor and said hinged jaw, wherein said actuator is positioned on said hinged jaw such that said microprocessor is positioned for motivating said actuator for selectively pivoting said hinged jaw concurrent with said speaker broadcasting the respective audio file; and
wherein said holes are positioned in said housing such that each said hole is positioned for inserting the respective article of the mounting hardware for coupling said housing to the structure, wherein said data storage module is positioned in said housing such that said receiver is positioned for selectively transferring the plurality of audio files from the electronic device of the user to said data storage module, wherein said sensor is positioned on said housing such that said sensor is configured for detecting the person entering the area proximate to said housing and for signaling said microprocessor, wherein said speaker is positioned on said housing such that said microprocessor is positioned for effecting the command requiring said data storage module to broadcast the respective audio file via said speaker to the person proximate to said housing, wherein said actuator is positioned on said hinged jaw such that said microprocessor is positioned for motivating said actuator for selectively pivoting said hinged jaw concurrent with said speaker broadcasting the respective audio file.
